(19) United States
(12) Patent Application Publication
(10) Pub. No.: US 2021/0338020 A1
(43) Pub. Date: Nov. 4, 2021

(54) MOTOR INTAKE SEALING FILTRATION SYSTEM FOR HAND DRYER

(71) Applicant: Scott Fetzer SFEG, Fairview, TN (US)

(72) Inventors: Daniel K. Amonett, Murfeesboro, TN (US); Matthew Quinn, Brentwood, TN (US); Adam Finch, Franklin, TN (US)

(73) Assignee: Scott Fetzer SFEG, Fairview, TN (US)

(21) Appl. No.: 16/864,851

(22) Filed: May 1, 2020

(51) Int. Cl. A47K 10/48; B01D 46/00

(52) U.S. Cl. CPC A47K 10/48; B01D 46/0005; B01D 2279/00; B01D 2271/02; B01D 46/002

(57) ABSTRACT

Provided in this disclosure is a hand dryer including a mounting structure having a planar surface for adjoining to a planar surface of a mounting wall upon which the hand dryer is mounted. A motor is provided for rotating a fan that generates an air flow. The motor is mounted transversely upon the mounting structure such that a plane of motor rotation is parallel to the planar surface of the mounting wall, and an axis of motor rotation is perpendicular to the mounting wall. The nozzle receives the air flow from the motor, and directs the air flow toward hands of a user. The hand dryer includes air intakes, mounted along opposite sides the motor, for receiving transverse flows of air. The air intake also includes a recessed portion, configured between the air intakes, for receiving the motor, and fluidly connecting the motor to the air intakes.

### I. BACKGROUND

### A. Technical Field

This invention pertains to the field of hand dryers that blow air onto the hands of a user to remove water after hand washing. The invention particularly pertains to hand dryers that conform with government requirements to serve the needs of special sectors of the public, such as the Americans with Disabilities Act (ADA).

### B. Description of Related Art

Hand dryers are commonly found in public venues that blow air onto the hands of a user to remove water after hand washing. Such hand dryers include a motor that rotates an impeller or fan to direct a flow of drying air through a nozzle and onto the hands of the user.

Conventional types of hand dryers, especially high-speed hand dryers, rely on a motor mounted in an axial direction for drawing air in through an intake located on the top or the side of the dryer, and directing it past the motor and out through a nozzle on the bottom. As used herein, the “axial direction” refers to a motor which is mounted in the dryer with its axis of rotation parallel to the mounting wall, so that the radius of the motor extends perpendicular to the wall.

In order to comply with ADA requirements, a hand dryer unit should have a height of less than 100 millimeters or 4 inches. In this instance, the term “height” refers to the distance between the front of the hand dryer unit and the mounting wall, and not a distance above the floor. However, a hand dryer with a motor mounted in the axial direction would have to have a radius larger than the ADA compliance requirement of less than 4 inches (i.e., <4″) in order to generate a sufficiently large flow of air for effective hand drying. Thus, the ADA compliance requirement of <4″ is not met by an axially mounted motor.

### II. SUMMARY

Provided in this disclosure is a hand dryer including a mounting structure, a motor, a nozzle and an air intake. The mounting structure has a planar surface for adjoining to a planar surface of a mounting wall upon which the hand dryer is mounted. The motor is provided for rotating a fan that generates an air flow. The motor is mounted transversely upon the mounting structure such that a plane of motor rotation is parallel to the planar surface of the mounting wall, and an axis of motor rotation is perpendicular to the mounting wall. The nozzle receives the air flow from the motor, and directs the air flow toward hands of a user.

The hand dryer includes a novel air intake design for supplying air to the motor. The air intake includes a first side side-mounted air intake, mounted along a first side the motor, for receiving a first transverse flow of air. The air intake also includes a corresponding second side side-mounted air intake, mounted along a second side the motor opposite the first side, for receiving a second transverse flow of air. The air intake also includes a recessed portion, configured between the first and second side-mounted air intakes, for receiving the motor, and fluidly connecting the motor to the first and second side-mounted air intakes.

Both of the first and second side-mounted air intakes each include respective first and second inlet chambers that are open to the ambient air, and each are respectively, connected to first and second inlet apertures connected to the motor. The inlet chambers both have a larger cross-sectional area than the inlet apertures, in order to provide greater air pressure in the inlet chambers and greater air velocity in the inlet apertures.

According to an aspect of the invention, a hand dryer is provided having a motor mounted in a transverse direction that provides suitable airflow for hand drying.

According to another aspect of the invention, a hand dryer is provided having a height above the mounting surface of less than 100 millimeters or 4 inches.

According to yet another aspect of the invention, a hand dryer is provided that complies with ADA requirements.

Other benefits and advantages of this invention will become apparent to those skilled in the art to which it pertains upon reading and understanding of the following detailed specification.

### III. BRIEF DESCRIPTION OF THE DRAWINGS

The disclosed hand dryer may take physical form in certain parts and arrangement of parts, embodiments of which will be described in detail in this specification and illustrated in the accompanying drawings which form a part hereof and wherein:

FIG. 1 is a perspective view of a hand dryer in accordance with an exemplary embodiment of the present invention.

FIGS. 2A and 2B are respective front and side views of a hand dryer in accordance with an exemplary embodiment of the present invention.

FIG. 3 is a cross-sectional top view of the hand dryer in accordance with an exemplary embodiment of the present invention, taken along the section line A-A as shown in FIG. 2A.

FIG. 4 is a cross-sectional perspective view of the hand dryer in accordance with an exemplary embodiment of the present invention, taken along the section line B-B as shown in FIG. 2B.

FIG. 5 is a rear perspective view of the hand dryer without the mounting structure, to illustrate the air flow through the air intakes and into the motor in accordance with an exemplary embodiment of the present invention.

FIGS. 6A and 6B are respective frontal views and cross-sectional views along section line A-A of FIG. 6A of an air intake structure in accordance with an exemplary embodiment of the present invention.

FIG. 7 is a cross-sectional view of a hand dryer showing air flow through the components in accordance with an exemplary embodiment of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components, a hand dryer 10 is disclosed herewith.

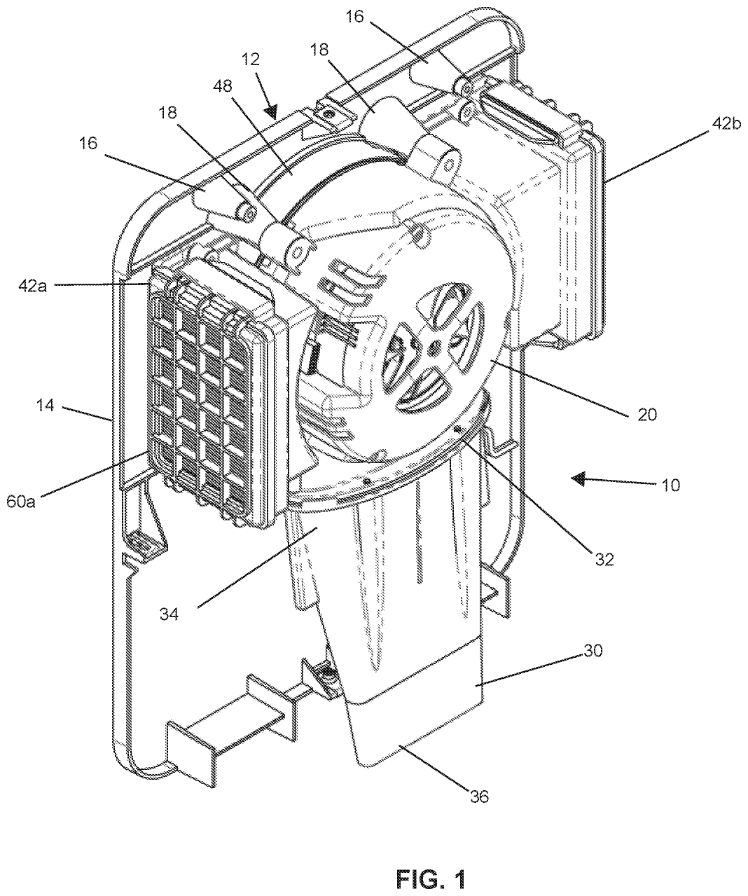

As shown in FIG. 1, the hand dryer 10 is depicted without an external housing (not shown) to reveal the internal components and their respective operations. It is to be appreciated that the present hand dryer 10 is retained within such a housing in order to protect the internal components from damage and to protect the user from accidentally touching electrical and moving mechanical components, as such housings are understood in the art.

As depicted in FIG. 1, the hand dryer 10 includes a mounting structure 12 having a planar backplate 14 for adjoining to a planar surface of a mounting wall upon which the hand dryer 10 is mounted. As shown in the figure, the mounting structure 12 includes suitable connector structures 16 for attaching to an external housing and to internal components.

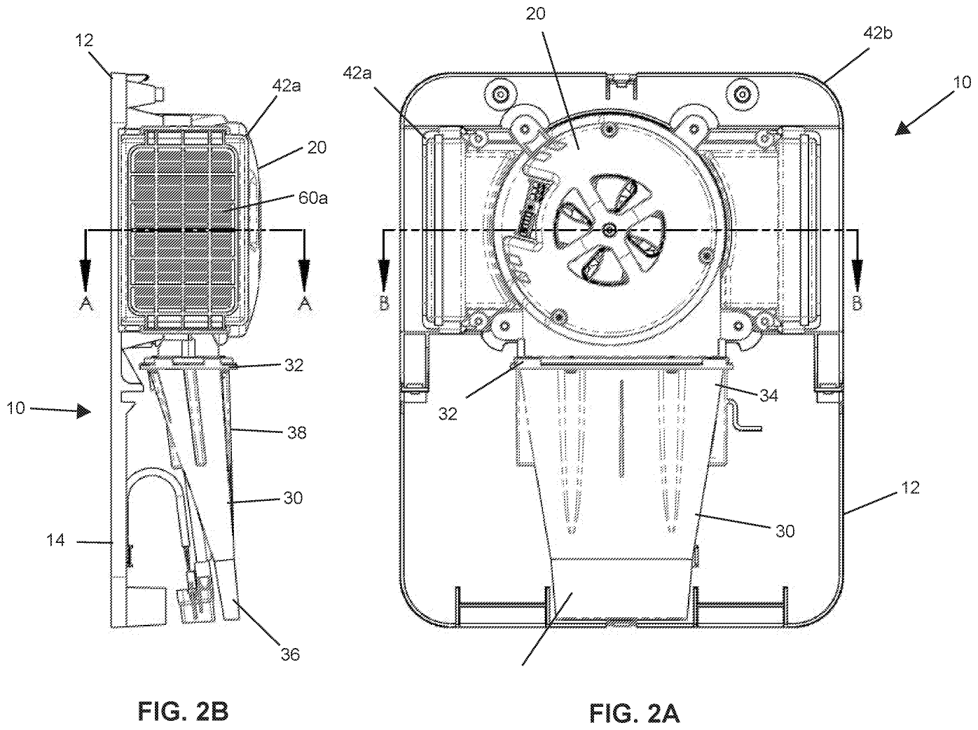

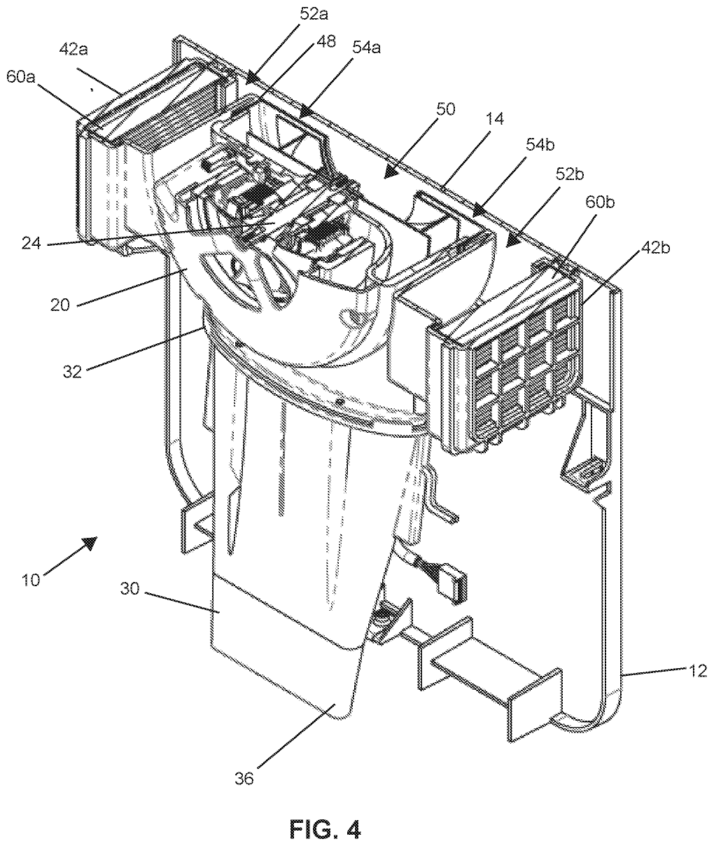

As shown, for example, in FIGS. 1, 2A, 2B, 3 and 4, a motor 20 is provided for rotating an impeller or fan 22 that in turn generates an air flow for the hand dryer 10, to provide a high-velocity flow of air for drying the hands of a user. The motor 10 is mounted transversely upon the mounting structure 12. The term “transversely” is used herein to connote that the plane of motor rotation (i.e., the plane in which the motor 20 rotates) is parallel to the planar surface of the mounting wall. The motor 20 has a shaft 24 around which the motor 20 rotates. The shaft 24 rotates around an axis of motor rotation which is perpendicular to the plane of rotation of the motor 20 and therefore also perpendicular to the mounting wall.

As shown in FIGS. 1, 2A, 2B, 4, and 5, a nozzle 30 is provided for receiving the air flow from the motor 20, and for directing the high-velocity air flow toward the hands of the user. As shown in the figures, a motor outlet 32 is configured for connecting the motor 20 to the nozzle 30. The motor outlet 32 is at the bottom of the motor 20 in a downward pointing direction (i.e., toward the floor) with respect to the mounting structure 12 and the mounting wall upon which the hand dryer 10 is mounted. Thus, the nozzle 30 is also pointed downward in the same manner. In the preferred embodiment the nozzle 30 is tapered so that an entrance 34 of the nozzle 30 where it connects to the motor outlet 32 has a larger cross-sectional area than at an exit 36 of the nozzle 30. In this manner, the pressure differential between the entrance 34 and the exit 36 results in increased speed of the air flow for blowing onto the user's hands, in accordance with the Venturi effect.

As shown in FIGS. 1, 2A, 4, and 5, the hand dryer 10 includes an air intake structure 40 for supplying air to the motor 20. The air intake structure 40 includes a pair of air intakes 42a, 42b. A first side side-mounted air intake 40a is mounted along a first side the motor 20 for receiving a first transverse flow of air. Similarly, a second side side-mounted air intake 40b is mounted along a second side the motor 20 opposite the first side, for receiving a second transverse flow of air. As depicted, the first side can be a left side of the hand dryer 10, as viewed from the front, while the second side can be a right side of the hand dryer 10. As depicted, the first and second air intakes 42a, 42b are mounted on opposite sides of the motor 20 so that the intakes 42a, 42b and the motor are essentially configured in a line.

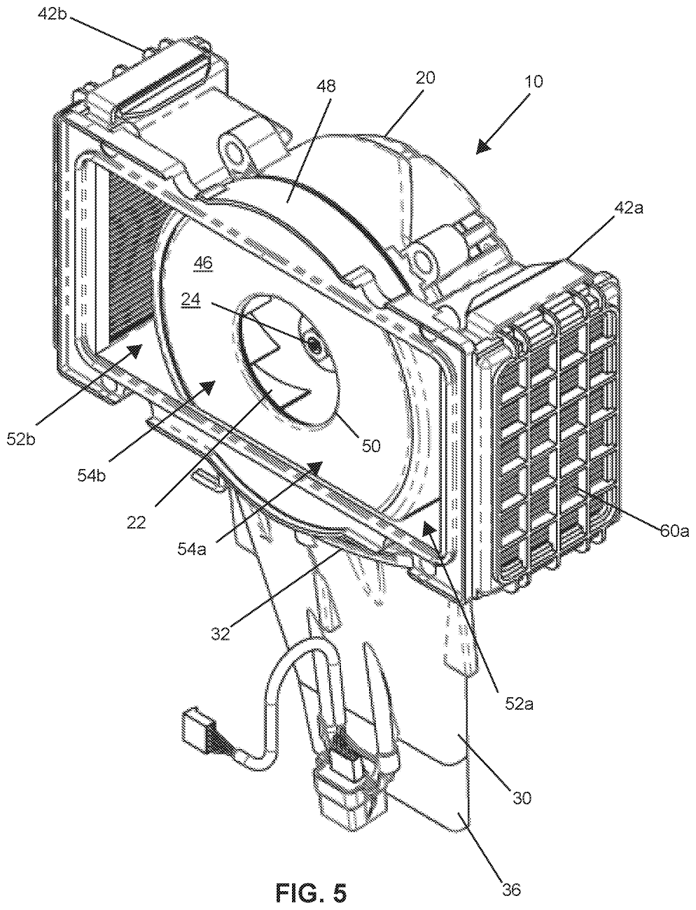

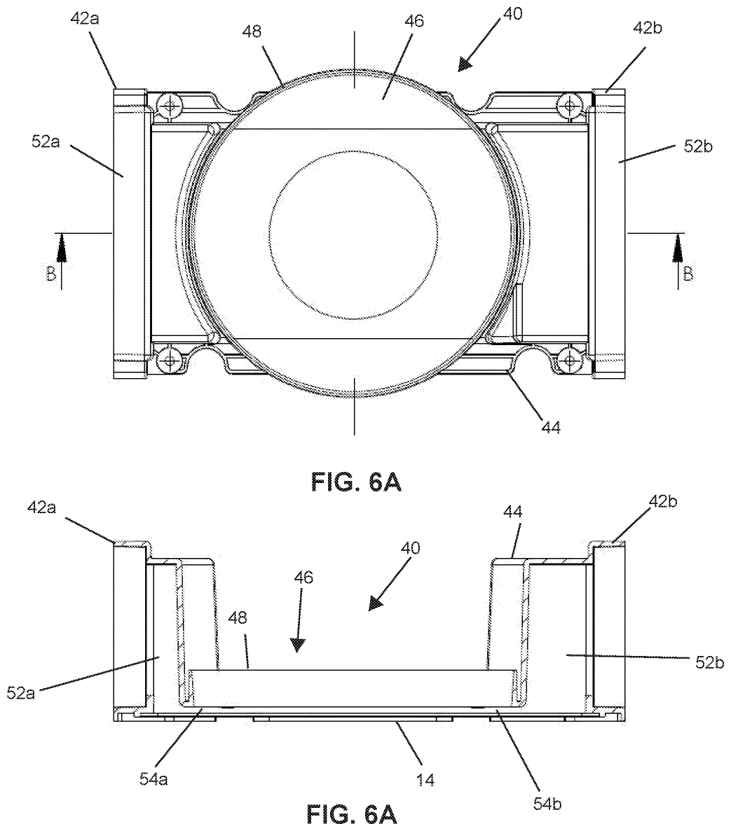

FIGS. 6A and 6B show only the air intake structure 40, separate from the other components of the hand dryer 10. The first and second air intakes 42a, 42b are formed as an integral housing 44 with a recessed portion 46, which is configured between the first and second side-mounted air intakes 42a, 42b. The recessed portion 46 includes a flat, circular section adjoining a support flange 48 for receiving the motor 20 and retaining the motor 20 securely therein. The support flange 48 extends in a perpendicular direction from the recessed portion 46, which defines a back surface of the air intake structure 40. The integral housing 44 of the air intake structure 40 is formed so that the recessed portion 46 fluidly connects the motor 20 to the first and second side-mounted air intakes 42a, 42b through a motor intake 50, as shown in FIG. 5, Thus, air flows into the air intakes 42a, 42b, through the motor 20, and out to the nozzle 30.

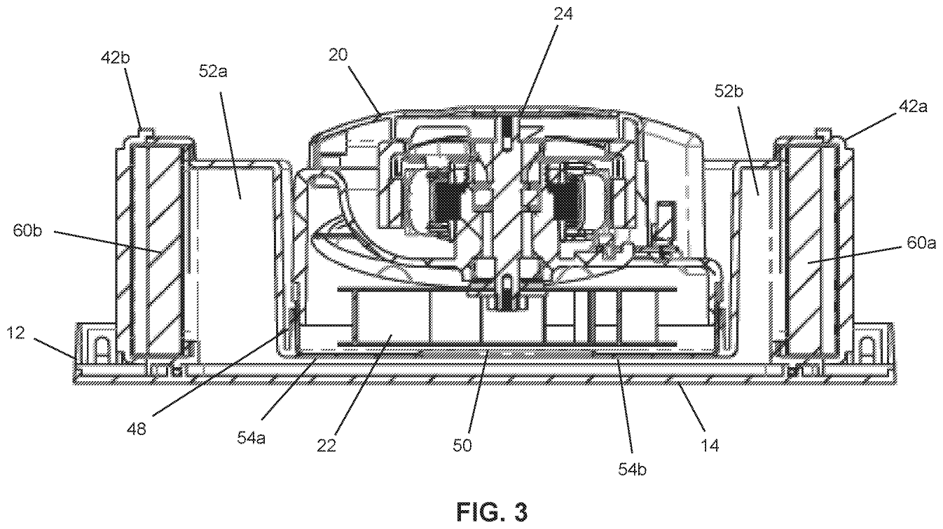

As particularly shown in FIGS. 3, 4, 5, and 7, and also in FIG. 6B (which shows a cross-sectional view along a section line A-A of FIG. 6A), the air intake structure 40 includes the first and second side-mounted air intakes 42a, 42b which each include respective first and second inlet chambers 52a, 52h that are open to ambient air. The inlet chambers 52a, 52b are respectively connected to first and second inlet apertures 54a, 54b which are in turn fluidly connected to the motor 20.

As depicted in FIG. 6A, the inlet apertures 54a, 54b are essentially flat, thin, wide passages that respectively extend from the inlet chambers 52a, 52b and are open to the motor intake 50 (FIG. 5) and into the motor 20. As is apparent from FIG. 6B, the inlet chambers 52a, 52b have a larger cross-sectional area than the inlet apertures 54a, 54b. The cross-sectional area of the inlet chambers 52a, 52b is tapered down to the smaller cross-sectional area at the opening to the inlet chambers 54a, 54b. This reduction in cross-sectional area results in greater air pressure in the inlet chambers 52a, 52b but greater air velocity in the inlet apertures 54a, 54b, in accordance with the Venturi effect.

As shown in FIG. 3, the inlet apertures 54a, 54b are sealed from behind by contact with the mounting structure 12, which defines a back wall of the inlet apertures 54a, 54b. The backplate 14 and the mounting structure 12 are not shown in FIG. 5 so that the inlet apertures 54a, 54b are shown in an open state. It is apparent from FIG. 5 that the inlet apertures 54a, 54b have a generally similar dimension as the adjoining side of the inlet chambers 52a, 52b, but a narrower cross-sectional area of the flow passages. In this manner, the inlet chambers 52a, 52b provide increased air pressure and the tapering down an angled surface to the inlet apertures 54a, 54b increases the velocity and thus CFM capability of the motor.

As shown in FIGS. 3, 5, 6A and 7, the first and second inlet apertures 54a, 54b are air flow passageways defined by a back side of the recessed portion 46, in contact with the motor 20, and the backplate 14 defined by an adjoining surface of the mounting structure 12. The back side of the recessed portion 46 that defines the first and second inlet apertures 54a, 54b includes the motor intake 50 which is an opening that admits the respective first and second transverse flows of air into fluid contact with the fan 22.

As evident from FIGS. 1, 2A, 3, 4, 5, 6A, 6B, and 7, the inlet chambers 52a, 52b face substantially away from the motor 20 in respective opposite directions parallel to the planar surfaces of the mounting structure and mounting wall, and perpendicular to the axis of motor rotation. Further, as shown in FIGS. 1, 2B, 4, and 5 the first and second air intakes 42a, 42b include respective first and second filters 60a, 60b configured along respective exterior openings of the air intakes 42a, 42b. The filters 60a, 60b are removable and replaceable and provide filtration of outside ambient air to prevent particulate matter from entering the hand dryer 10.

As shown in FIGS. 1, 2A, 4, and 5 the first and second air intakes 42a, 42b and the motor 20 are configured in a generally horizontal orientation with respect to the mounting structure 12. The motor 20 and the nozzle 30 are configured in a generally vertical orientation with respect to the mounting structure 12. The horizontal orientation and the vertical orientation are generally perpendicular, so that the first and second air intakes 42a, 42h, the motor 20, and the nozzle 30 define a generally T-shaped configuration.

As a special feature of the present invention, the transversely mounted motor 20 has a vertical height above the mounting structure 12 of less than four inches, in order to comply with Americans with Disabilities Act (ADA) requirements. As explained hereinabove, the term “transverse” refers to a motor 30 that is mounted within the assembly of the hand dryer 10 with its axis of rotation perpendicular to the mounting wall, so that the radius of the motor 20 extends in a plane parallel to the wall. In this manner, the overall height envelope is in compliance with the ADA requirement and the motor 20 cooperates with an air intake structure 40 that can properly feed the required air to the transversely mounted motor 20.

In the preferred embodiment, the motor 20 is an Outer Rotor Brushless DC motor, mounted transversely, that takes air in through the air intake and filtration structure as explained hereinabove and accelerates the air out though a nozzle on the bottom. The overall utility of the intake and mounting configuration of the outer rotor design allows the overall height of the structure to be reduced to the point that the present hand dryer 10 meets the ADA requirements of a height<4″ from the wall. This gives us a significant improvement in air efficiency and performance in the given packaging envelope. In addition, the transverse orientation of the motor 20 produces a quieter, more efficient and better performing hand dryer 10. Moreover, the transverse orientation enables the overall packaging of a more powerful motor having a larger radius while maintaining<4″ height requirement, thereby providing greater performance.

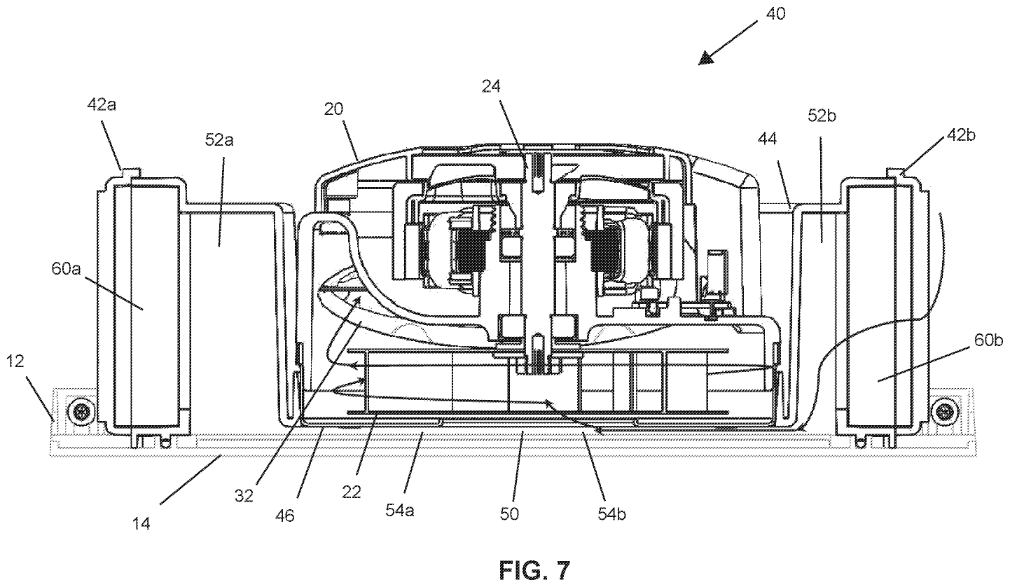

FIG. 7 shows the flow of air into and through the air intake structure 40 and into the motor 20. The air is drawn through the filters 60a, 60b and into the air intakes 42a, 42b, where they pass from the inlet chambers 52a, 52b into the inlet apertures 54a, 54b. The unique air intake structure 40, particularly defined by the recessed portion 46 and the support flange 48, forces air to change directions at the motor intake 50, which reduces overall packaging size (height) of the structure, improves performance, and reduces noise. The air swirls around the fan 22, and out the motor outlet 32 and through the nozzle 30.

The geometry of the design of the air intake structure 40 allows a large volume of air to be passed through filters 60a, 60b and channeled down to the motor intake 50. The structure 40 provides an integral seal against the backplate 14 creating a channel that accelerates the air to the motor intake 50. This geometry solves the problem of trying to get sufficient filtered air to the transverse mounted motor while keeping the overall height of the hand dryer 10 to under 4″, thus allowing the hand dryer 10 to be ADA compliant.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A hand dryer, comprising:
a mounting structure having a planar surface for adjoining to a planar surface of a mounting wall upon which the hand dryer is mounted;
a motor for rotating a fan that generates an air flow, wherein the motor is mounted transversely upon the mounting structure such that a plane of motor rotation is parallel to the planar surface of the mounting wall, and wherein an axis of motor rotation is perpendicular to the mounting wall;
a nozzle for receiving the air flow from the motor; and for directing the air flow toward hands of a user; and
an air intake for supplying air to the motor, the air intake comprising:
a first side side-mounted air intake, mounted along a first side the motor, for receiving a first transverse flow of air;
a second side side-mounted air intake, mounted along a second side the motor opposite the first side; for receiving a second transverse flow of air;
a recessed portion, configured between the first and second side-mounted air intakes, for receiving the motor, and fluidly connecting the motor to the first and second side-mounted air intakes.

2. The hand dryer of claim wherein the first and second side-mounted air intakes each comprise respective first and second inlet chambers that are open to ambient air, and are respectively connected to first and second inlet apertures connected to the motor, wherein the inlet chambers have a larger cross-sectional area than the inlet apertures, in order to provide greater air pressure in the inlet chambers and greater air velocity in the inlet apertures.

3. The hand dryer of claim 2, wherein the first and second inlet apertures define a back side of the recessed portion; in contact with the motor and a back plate substantially adjoining the mounting structure, and wherein the back side defined by the first and second inlet apertures further comprises a motor intake comprising an opening to admit the respective first and second transverse flows of air into contact with the fan.

4. The hand dryer of claim 2, wherein the inlet chambers face substantially away from the motor in respective directions parallel to the planar surfaces of the mounting structure and mounting wall, and perpendicular to the axis of motor rotation.

5. The hand dryer of claim 1, wherein the first and second air intakes further comprise respective first and second filters configured along respective exterior openings.

6. The hand dryer of claim 1, further comprising a motor outlet for connecting the motor to the nozzle.

7. The hand dryer of claim 1, wherein the first and second air intakes and the motor are configured in a generally horizontal orientation with respect to the mounting structure, and wherein the motor and the nozzle are configured in a generally vertical orientation with respect to the mounting structure, wherein the horizontal orientation and the vertical orientation are generally perpendicular, so that the first and second air intakes, the motor; and the nozzle define a generally T-shaped configuration.

8. The hand dryer of claim 1, wherein the motor has a vertical height above the mounting structure of less than four inches; in compliance with Americans with Disabilities Act (ADA) requirements.

9. A hand dryer, comprising:
a mounting structure having a planar surface for adjoining to a planar surface of a mounting wall upon which the hand dryer is mounted;
a motor for rotating a fan that generates an air flow, wherein the motor is mounted transversely upon the mounting structure such that a plane of motor rotation is parallel to the planar surface of the mounting wall, and wherein an axis of motor rotation is perpendicular to the mounting wall;
a nozzle for receiving the air flow from motor, and for directing the air flow toward hands of a user; and
an air intake for supplying air to the motor, the air intake comprising:
a first side side-mounted air intake, mounted along a first side the motor; for receiving a first transverse flow of air;
a second side side-mounted air intake, mounted along a second side the rotor opposite the first side; for receiving a second transverse flow of air;
a recessed portion, configured between the first and second side-mounted air intakes, for receiving the motor, and fluidly connecting the motor to the first and second side-mounted air intakes;
wherein the first and second side-mounted air intakes each comprise:
respective first and second inlet chambers open to ambient air, and respectively connected to first and second inlet apertures connected to the motor, wherein the inlet chambers have a larger cross-sectional area than the inlet apertures, in order to provide greater air pressure in the inlet chambers and greater air velocity in the inlet apertures.
